(19) United States
(12) Patent Application Publication
(10) Pub. No.: US 2013/0159513 A1
(43) Pub. Date: Jun. 20, 2013

(54) INFORMATION PROCESSING SYSTEM AND OPERATION MANAGEMENT METHOD

(71) Applicant: HITACHI, LTD., Tokyo (JP)

(72) Inventors: Masato HAYASHI, Tokyo (JP); Takeshi KATO, Tokyo (JP); Yasuhiro ASA, Tokyo (JP)

(73) Assignee: HITACHI, LTD., Tokyo (JP)

(21) Appl. No.: 13/716,415

(22) Filed: Dec. 17, 2012

(30) Foreign Application Priority Data
Dec. 19, 2011 (JP) 2011-276621

(51) Int. Cl. H04L 12/26

(52) U.S. Cl. CPC H04L 43/00
USPC 709/224

(57) ABSTRACT

An object is to prevent overload on a shared resource. In an information processing system including a resource possibly shared between a plurality of work loads, an additional load is applied to the resource while operating the work loads, and the performances of the work loads are monitored.

### CLAIM OF PRIORITY

The present application claims priority from Japanese Patent Application JP2011-276621 filed on Dec. 19, 2011, the content of which is hereby incorporated by reference into this application.

### BACKGROUND OF THE INVENTION

The present invention relates to an information processing system and an operation management method for an information processing system, and more particularly to the efficient use of the resources of an information processing system.

A plurality of work loads possibly affect the performances of the work loads to each other when sharing the resources of an information processing system. There is a technique that optimizes the operations of a plurality of applications by adjusting application parameters in the case where resources configuring an information processing system are shared between the applications (International Publication No. WO2008/006027).

### BRIEF SUMMARY OF THE INVENTION

In the technique disclosed in International Publication No. WO2008/006027, the overhead of processing occurs for optimizing application parameters. On the contrary, in allocating a plurality of work loads in an information processing system including resources possibly shared between the work loads, for example, when allocation is made so as not to overload a resource shared between the work loads (in the following, referred to as a shared resource), it is unnecessary to optimize application parameters, and the performance of the entire system is improved.

The present invention is made in view of the above problem. It is an object to prevent overload on a shared resource.

In a representative aspect of the present application, in an information processing system including a resource possibly shared between work loads, an additional load is applied to the resource, and the performances of the work loads are monitored while performing the work loads.

According to the aspect of the present invention, it is possible to allocate work loads based on the result of monitoring the performances of the work loads, and it is possible to prevent overload on a shared resource.

### BRIEF DESCRIPTION OF THE DRAWINGS

The present invention will become fully understood from the detailed description given hereinafter and the accompanying drawings, wherein:

FIG. 1 is a block diagram of an information processing system according to an embodiment of the present invention;

FIG. 2 is a diagram of exemplary performance policy information;

FIG. 3 is a schematic diagram for describing a state in which a plurality of work loads share a physical resource;

FIG. 4 is a diagram schematically illustrating the plot of changes in the performance of a work load with respect to a load amount applied to a network interface;

FIG. 5 is a diagram of exemplary performance tables;

FIG. 6 is a block diagram of an information processing system according to an embodiment of the present invention;

FIG. 7 is a diagram schematically illustrating an exemplary relationship between the performance of a work load and a resource used amount;

FIG. 8 is a flowchart for describing an exemplary operations of measuring work load performance and acquiring a performance table in an information processing system according to an embodiment of the present invention;

FIG. 9 is a diagram of exemplary performance policy information;

FIG. 10 is a diagram for schematically describing the performances of work loads with respect to resource used amounts;

FIG. 11 is a diagram for schematically describing the performances of work loads with respect to resource used amounts;

FIG. 12 is a block diagram of an information processing system according to an embodiment of the present invention;

FIG. 13 is a diagram of exemplary performance policy information;

FIG. 14 is a diagram for schematically describing the performances of work loads with respect to resource used amounts;

FIG. 15 is a diagram for schematically describing the performances of work loads with respect to resource used amounts;

FIG. 16 is a block diagram of an information processing system according to an embodiment of the present invention; and

FIG. 17 is a flowchart of an example of the allocation and operation of work loads in an information processing system according to an embodiment of the present invention.

### DETAILED DESCRIPTION OF THE INVENTION

In the following, embodiments of the present invention will be described with reference to the drawings.

### First Embodiment

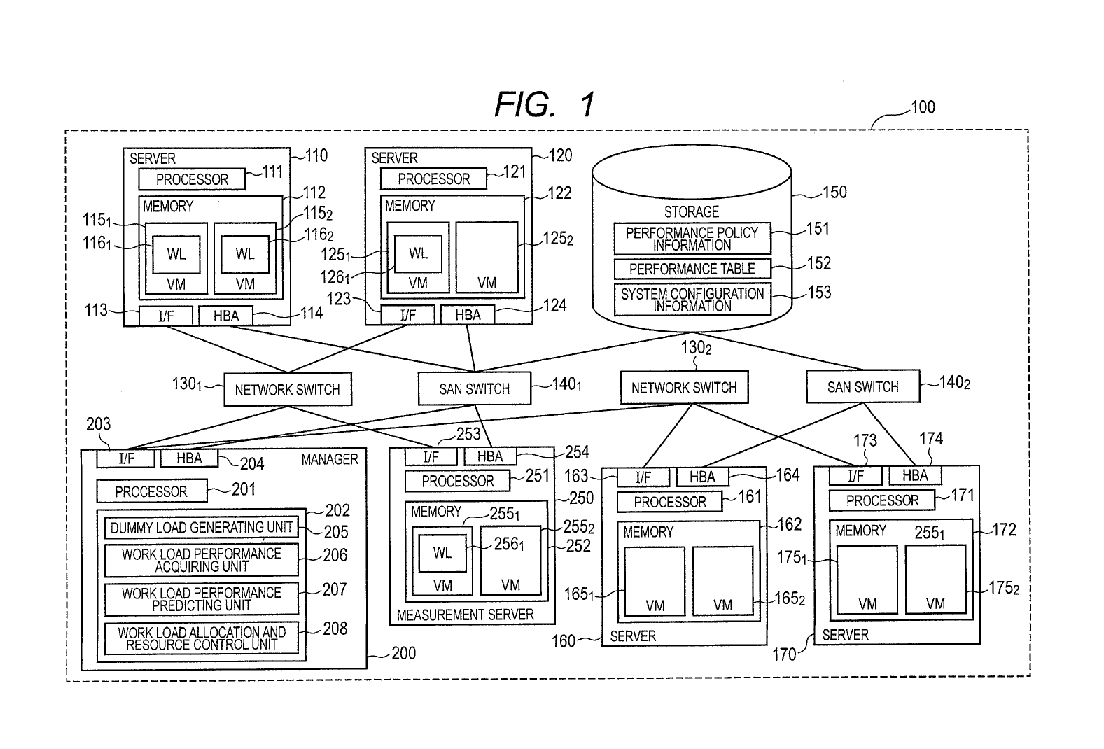

FIG. 1 is an information processing system 100 according to an embodiment of the present invention. The information processing system 100 includes a server device 110, a server device 120, network switches 130₁ and 130₂ as network devices, storage area network (SAN) switches 140₁ and 140₂ similarly as network devices, a storage device 150, a server device 160, a server device 170, a manager server device 200, and a measurement server device 250. The server device 110, the server device 120, the manager server device 200, and the measurement server device 250 are connected to each other through the network switch 130₁. Moreover, the server device 110, the server device 120, the storage device 150, the manager server device 200, and the measurement server device 250 are connected to each other through the SAN switch 140₁. Therefore, the network switch 130₁ and the SAN switch 140₁ are shared between the server device 110 and the server device 120.

The server device 160, the server device 170, and the manager server device 200 are connected to each other through the network switch 130₂. Furthermore, the server device 160, the server device 170, and the storage device 150 are connected to each other through the SAN switch 140₂. Therefore, the network switch 130₂ and the SAN switch 140₂ are shared between the server device 160 and the server device 170.

It is noted that in the embodiment, the network switches 130₁ and 130₂ are formed under the same specifications. Furthermore, in the embodiment, the SAN switches 140₁ and 140₂ are formed under the same specifications. In addition, the information processing system 100 can expand the system by further increasing sets of server devices, network switches, and SAN switches having connections similar to the connections between the server devices 160 and 170, the network switch 130₂, and the SAN switch 140₂ as necessary.

The server device 110 that is an information processing apparatus includes a processor 111, a memory 112, a network interface (I/F) 113, and a host bus adapter (HBA) 114 that is an interface to connect to the storage device 150. Such an example is illustrated in a state in which virtual machines (VM) 115₁ and 115₂ are stored on the memory 112. Such an example is illustrated in a state in which a work load (WL) 116₁ is operated on the virtual machine 115₁ and a work load 116₂ is operated on the virtual machine 115₂.

In the embodiment, the server device 120 is formed under the same specifications as the server device 110, including a processor 121, a memory 122, a network interface (I/F) 123, and a host bus adapter 124 that is an interface to connect to the storage device 150. Such an example is illustrated in a state in which virtual machines 125₁ and 125₂ are stored on the memory 122. Such an example is illustrated in a state in which a work load 126₁ is operated on the virtual machine 125₁.

In the embodiment, the server device 160 is formed under the same specifications as the server device 110, including a processor 161, a memory 162, a network interface (I/F) 163, and a host bus adopter 164 that is an interface to connect to the storage device 150. Such an example is illustrated in a state in which virtual machines 165₁ and 165₂ are stored on the memory 162. In the embodiment, it is supposed that the server device 170 is formed under the same specifications as the server device 110, including a processor 171, a memory 172, a network interface (I/F) 173, and a host bus adapter 174 that is an interface to connect to the storage device 150. Such an example is illustrated in a state in which virtual machines 175₁ and 175₂ are stored on the memory 172. In FIG. 1, such an example is illustrated in a state in which the servers 160 and 170 are stopped for suppressing power consumption, and no work load is applied.

The manager server device 200 includes a processor 201, a memory 202, a network interface (I/F) 203, and a host bus adapter 204 that is an interface to connect to the storage device 150. In FIG. 1, such a state is illustrated in which a dummy load generating unit 205, a work load performance acquiring unit 206, a work load performance predicting unit 207, and a work load allocation and resource control unit 208 are stored on the memory 202 as programs to operate the processor 201.

In the embodiment, the measurement server device 250 is formed under the same specifications as the server device 110, including a processor 251, a memory 252, a network interface (I/F) 253, and a host bus adapter 254 that is an interface to connect to the storage device 150. Such an example is illustrated in a state in which virtual machines 255₁ and 255₂ are stored on the memory 252. Such an example is illustrated in a state in which a work load 256₁ is operated on the virtual machine 255₁.

The server device 110, the server device 120, the server device 160, and the server device 170 process work loads inputted to the information processing system 100. An administrator determines to allocate the virtual machines to the server devices 110, 120, 160, and 170. The manager server device 200 determines to allocate a work load to which one of the server devices 110, 120, 160, and 170 according to a method described later.

The manager server device 200 allocates the work loads inputted to the information processing system 100 based on the result of monitoring the performances of the work loads while applying loads caused by the work loads and an additional load to a resource such as the network switch 130₁ and the SAN switch 140₁; the resource is possibly affected on the performances of the work loads due to conflict when the resource is shared between the work loads.

The measurement server device 250 receives an instruction from the manager server device 200, and operates a test work load to communicate with the dummy load generating unit 205 through the network switch 130₁, and applies a load to the network switch 130₁. It is noted that in the embodiment, the server device 250 is referred to as a measurement server device for easy understanding. The measurement server device 250 is a server device to which a test work load is applied in measuring work load performance, described later. In the case where work load performance is not measured, the server device 250 can function as a server as similar to the server device 110.

The storage device 150 stores performance policy information 151, a performance table 152, and system configuration information 153, which are used in processing in the manager server device 200. Moreover, the storage device 150 stores work loads, programs, data, and so on used in the information processing apparatuses.

The performance policy information 151 includes parameters indicating the necessary performances of work loads to be maintained at the minimum after predicting the deterioration of performance due to conflict between a work load and another work load sharing a resource in operating work loads on the information processing system 100. The performance policy information 151 is inputted by a user as parameters before allocating a work load, for example.

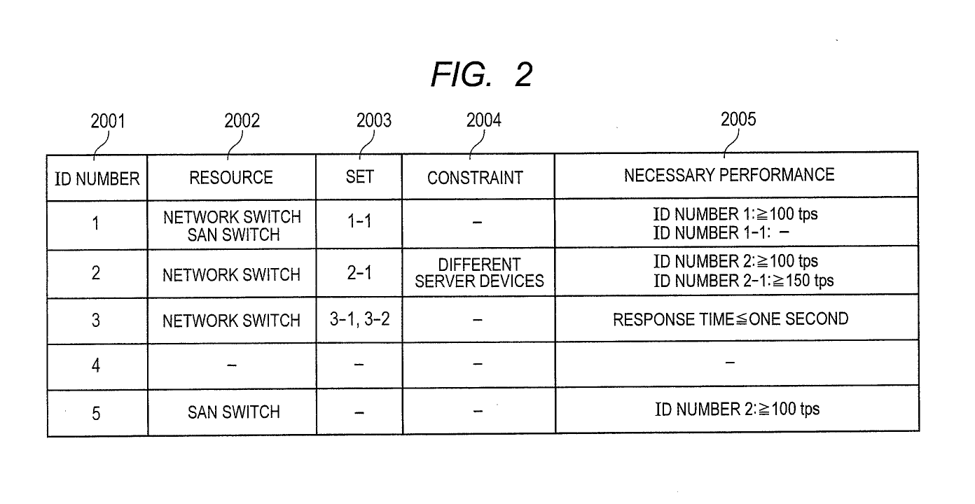

FIG. 2 is an example of the performance policy information 151. The performance policy information in FIG. 2 includes a work load ID number 2001, information 2002 about resources to which an additional load is applied, information 2003 about work loads to make a set, information 2004 about constraints of the disposition of work loads, and corresponding necessary performance information 2005. The work load ID number 2001 may be numbers that can uniquely identify work loads on the information processing system 100. For example, the work load ID number 2001 can be obtained by giving serial numbers in the order of inputting work loads to the information processing apparatus 100.

The resource information 2002 to apply an additional load is information that identifies a resource to which an additional load is applied in measuring work load performance, described later, for a work load identified by the ID number 2001. In the information 2003 about the resources to which an additional load is applied, at least one resource is inputted to the ID number like ID numbers “1”, “2”, “3”, and “5”, or no resource is inputted to the ID number like an ID number “4” in the case where it is unnecessary to measure work load performance.

The information 2003 about work loads to make a set receives a number to identify a work load on which work load performance is measured in combination with a work load identified by the ID number 2001. In the case where a work load identified by an ID number is alone subjected to work load performance measurement, no data is inputted to the work load information 2003 about work loads to make a set like the ID number “5”.

The work load disposition constraint information 2004 includes information about a work load disposition constraint applied to a work load identified by the ID number 2001 and a work load to make a set described in the information 2003. Data is inputted to the work load disposition constraint information 2004 in the case where applications that are work loads are disposed in a plurality of server devices for synchronization and data transfer between the applications through a network device because of redundancy such as mirroring or parallel processing in a plurality of calculation nodes, for example. In FIG. 2, an example is illustrated that a constraint is put in the ID number “2” as the constraint information 2004 in which the work load of the ID number “2” and a work load “2-1” to make a set with the work load of the ID number “2” are separately disposed in “different server devices”.

The necessary performance information 2005 includes the necessary performances of a work load identified by the ID number 2001 and a work load to make a set in the information 2003; the necessary performances are sought by the user, as necessary. In FIG. 2, one type of necessary performance is illustrated in the necessary performance information 2005 for the ID numbers. As for work loads to which a plurality of performance indexes can be defined, the user may determine policies so as to satisfy at least one requirement or all the requirements of the work loads. tps in FIG. 2 means the number of transactions per second. In FIG. 2, the following example is illustrated. For the work load of the ID number “1”, necessary performance is 100 transactions or more per second. For the work load of the ID number “1-1” on which work load performance is measured in combination with the work load of the ID number “1”, no request is made for necessary performance by the user. For the work load of the ID number “2”, necessary performance is 150 transactions or more per second. For the work load of the ID number “3”, necessary performance is response time within one second. For the work load of the ID number “5”, necessary performance is 100 transactions or more per second.

The system configuration information 153 includes system configuration information about the information processing system 100. For example, the system configuration information 153 includes information about the types and specifications of the server devices, the network switches, the SAN switches, and the storages included in the information processing system 100 and the connections between these devices.

The performance table 152 includes data showing the degrees of the deterioration of the performances of the work loads whose necessary performances included in the performance policy information 151 are shown. The degrees of the deterioration of the performances are obtained by measuring work load performance, described later, and the deterioration of the performances of the work loads is due to conflict with other work loads sharing resources. In the embodiment, the performance table 152 includes data of the relationship between load amounts applied to the resources listed on the resource information 2002 and the performances of the work loads, to the load amounts, whose necessary performances included in the performance policy information 151 are shown. Here, among resources, the resources for the performance policy information 151 and the performance table 152 are resources that possibly affect the performances of the work loads because the performances of the resources seen from the work loads are degraded due to conflict. The degradation of the performances of the resources seen from the work loads means that the resources are shared and thus degraded. For example, in the case of the network switch, communication throughput for the work loads is degraded. Examples of the load amounts on the shared resources include use frequency bands for the network interfaces, use frequency bands for the storage array, the CPU usage rate for IOPSs and the processors, the memory band width for a memory controller, and so on. Examples of work load performances to be measured include the number of transactions per unit time in online transaction processing, the average response time of requests in the web server, and so on. Moreover, in the case where it is known that CPU loads are dominant as in scientific technology calculation processing, CPU time used per unit time can be used for an index as work load performance.

In the information processing system 100 according to the embodiment, performance tables showing the quantitative relationship between the load amounts on the shared resources and the performances of the work loads on the load amounts are held, so that the influence on the performances of the work loads sharing the resources can be quantitatively predicted, and the allocation of the work loads can be determined based on the prediction. Therefore, the performance of the work load can be easily secured.

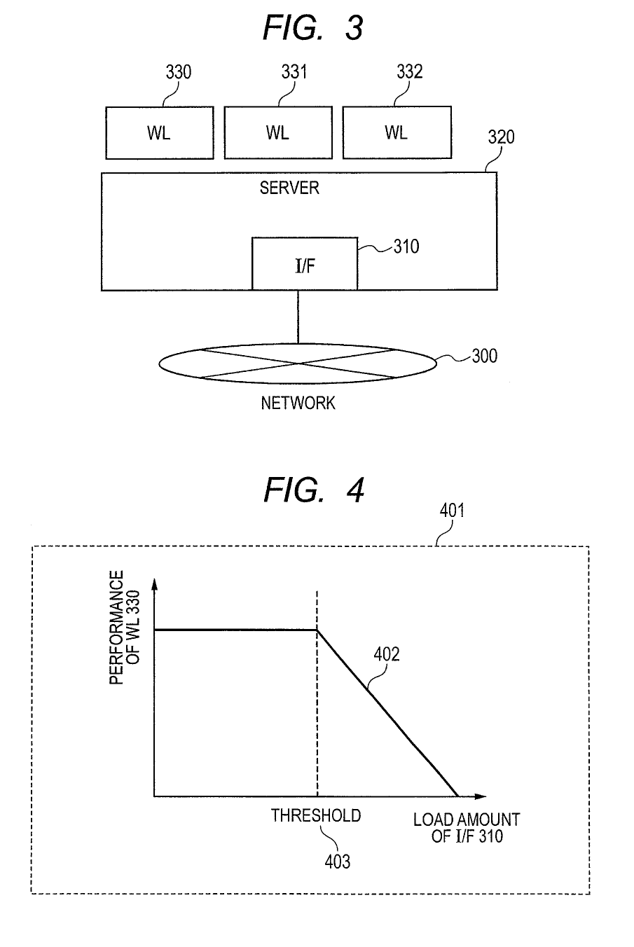

An exemplary conflict between work loads sharing resources will be described with reference to FIGS. 3 and 4. FIG. 3 is a schematic diagram for describing a state in which a plurality of work loads share a physical resource. Work loads 330, 331, and 332 are operated on the server device 320, and the work loads 330, 331, and 332 communicate with a network 300 through a network interface 310. In this example, the network interface 310 corresponds to a shared resource. In the case where a load on a shared resource is small, the influence on the performances of the work loads does not cause any problems. However, in the case where an excessive load is applied to a shared resource, the shared resource becomes a bottleneck, and the performances of the work loads is degraded. FIG. 4 exemplifies this relationship in the drawing. In a graph 401 in FIG. 4, the vertical axis expresses the performance of the work load 330, and the horizontal axis expresses a load amount applied to the network interface 310, in which a plot 402 schematically illustrates a change in the performance of the work load 330 with respect to the load amount applied to the network interface 310. When attention is focused on the performance of the work load 330, in the case where the load on the network interface 310 is smaller than a threshold 403, the performance of the work load 330 is almost constant, and this case corresponds to the case where the influences caused by the work loads 331 and 332 do not cause any problems. On the other hand, when the load on the network interface 310 exceeds the threshold 403, the performance of the work load 330 is degraded due to conflict with the work loads 331 and 332. The threshold 403 is an amount determined depending on the frequency band of the network interface, for example.

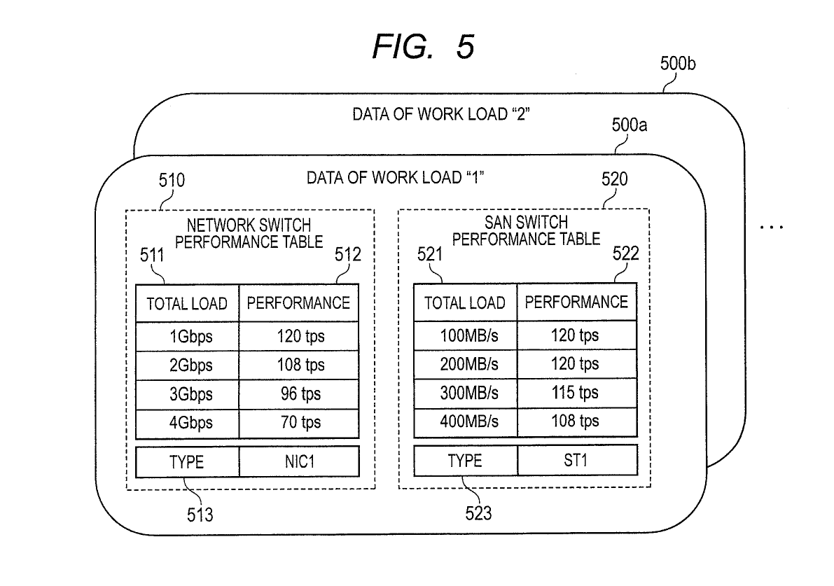

FIG. 5 is examples of the performance table 152 held in the storage 150. A performance table 500a is a performance table corresponding to the work load “1” in the work load ID number 2001 of the performance policy information in FIG. 2, including performance tables for individual types of shared resources described in the resource information 2002. The performance table 500a includes a performance table 510 for a network switch and a performance table 520 for a SAN switch. The performance table 510 for the network switch includes a load amount 511 on the switch, a work load performance 512 corresponding to the load amount, and network switch type information 513. Gbps in FIG. 5 is gigabit per second, and MB/s in FIG. 5 is megabit per second. The SAN switch performance table 520 also similarly includes a load amount 521 for the switch, a work load performance 522 corresponding to the load amount, and storage type information 523. In the embodiment, the performance tables for the network switch and the SAN switch are illustrated. Performance tables can be held for given types of resources possibly shared.

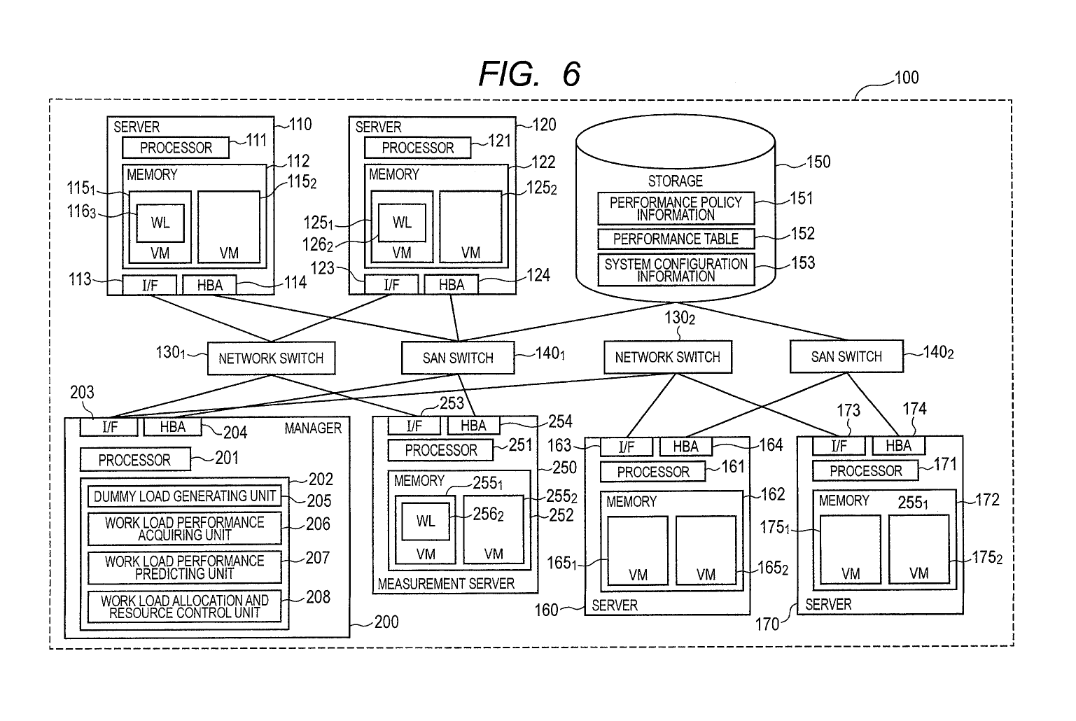

In the following, the operation of the work load performance acquiring unit 206 will be described with reference to FIGS. 6 to 9. FIG. 6 is a diagram of the information processing system 100 using a dummy load in measuring work load performance. It is noted that in FIG. 6, components having the same numbers in FIG. 1 are similar components in FIG. 1, and the description is omitted.

The virtual machines 115₁ and 115₂ are stored on the memory 112 of the server device 110. In the virtual machine 115₁, a work load 116₃ is operated. The virtual machines 125₁ and 125₂ are stored on the memory 122 of the server device 120. In the virtual machine 125₁, a work load 126₂ is operated.

The virtual machines 255₁ and 255₂ are stored on the memory 252 of the measurement server device 250. In the virtual machine 255₁, a work load 256₂ that applies a load to at least one of the network switch 130₁ and the SAN switch 140₁ is operated in cooperation with the dummy load generating unit 205 of the manager server device 200.

The work load 116₃ and the work load 126₂ apply loads to the network switch 130₁ by communicating data with each other during operation. During the operation of the work load 116₃ and the work load 126₂, the manager server device 200 changes a load amount applied to at least one of the network switch 130₁ and the SAN switch 140₁ by the dummy load generating unit 205 and the work load 256₂, and the work load performance acquiring unit 206 acquires the performance values of the work load 116₃ and 126₂ for every load amount on the network switch 130₁ and the SAN switch 140₁, which are resources possibly shard between the work loads.

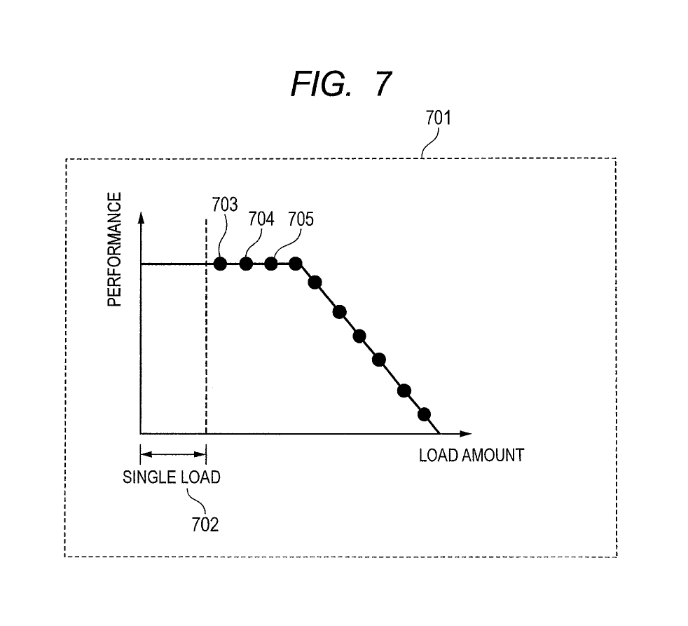

FIG. 7 is an exemplary relationship between the performance value of the work load and the resource used amount obtained as the result of operating the dummy load generating unit 205 and the work load performance table acquiring unit 206, and the relationship is schematically illustrated as a graph 701. In the graph 701, a load amount on a resource that causes interference when the resource is shared is plotted on the horizontal axis, and performance exerted by a work load at a certain amount is plotted on the vertical axis. A single load 702 is a load caused by a work load itself to be measured. Measurement results 703, 704, 705, and so on express the performance values of the work loads to be measured, which are acquired by the work load performance acquiring unit 206 in the state in which the dummy load generating unit 205 additionally applies a load to a resource. When the graph 701 is expressed in a table form, the graph 701 can be expressed in the form in FIG. 5.

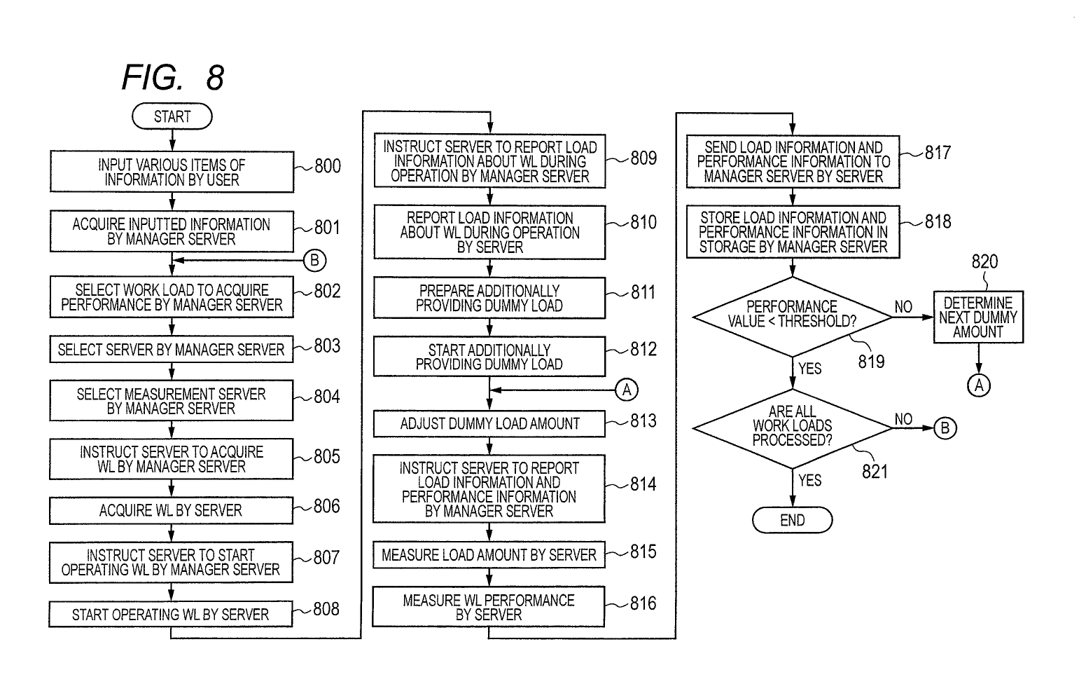

FIG. 8 is a flowchart of exemplary operations of measuring work load performance and acquiring the performance table 152 in the information processing system 100.

First, the user inputs information necessary to acquire the performance table 152 through the manager server device 200 (Step 800). The information to be inputted includes the performance policy information 151 and the system configuration information 153. Subsequently, the manager server device 200 acquires the performance policy information 152 and the system configuration information 153 out of the storage 150, and stores the information on the memory 202 (Step 801).

In Step 802, the manager server device 200 selects a work load whose performance is acquired in ascending order of numbers in the work load ID number 2001, for example. Subsequently, the manager server device 200 selects one server device, or a plurality of server devices, as necessary, used for measuring the performance of a work load based on the system configuration information 153 (Step 803). Moreover, the manager server device 200 selects one measurement server device to generate a dummy load, as necessary (Step 804). The user can in advance determine information about candidates for the server device and the measurement server device for measuring the performance value of the work load, and can store the information in the system configuration information 153.

In Step 805, the manager server device 200 instructs the server devices selected in Step 803 to acquire work loads to be measured out of the storage 150. The instructed server devices then acquire the instructed work loads out of the storage 150 (Step 806).

In Step 807, the manager server device 200 instructs the server devices selected in Step 803 to start to operate the acquired work loads. The server devices instructed to start to operate the acquired work load (Step 808). The manager server device 200 then instructs the servers starting the operation to report, to the manager server device 200, information about the load amount applied by the work load to the resource specified in the resource information 2002 (Step 809). The server devices instructed to report the information report, to the manager server device 200, the information about the load amount applied by the work load to the resource specified in the resource information 2002 (Step 810).

In Step 811, for the preparation of additionally applying a dummy load, when there is a measurement server device selected in Step 804, the manager server device 200 causes the measurement server device to acquire a work load to apply a load to a resource specified in the resource information 2002 out of the storage 150 in cooperation with the dummy load generating unit 205. The dummy load generating unit 205 and the measurement server device selected in Step 804, in the case where there is the measurement server device selected in Step 804, start to additionally apply a load to the resource specified in the resource information 2002, that is, the dummy load generating unit 205 and the measurement server start to additionally apply a dummy load (Step 812).

In Step 813, the manager server device 200 adjusts the dummy load amount applied to the resource specified in the resource information 2002. The work load performance acquiring unit 206 then instructs the servers selected in Step 803 to report information about the performance values of the work loads being operated on the servers and information about the load amounts that the work loads being operated on the servers apply to the resources specified in the resource information 2002 (Step 814). The servers selected in Step 803 then measure the load amounts that the work loads being operated on the servers apply to the resources specified in the resource information 2002 (Step 815). Moreover, the servers selected in Step 803 measure the performance values of the work loads being operated on the servers (Step 816). The servers selected in Step 803 send information about the measurement results in Steps 815 and 816 to the manager server device 200 (Step 817). The manager server device 200 stores information received from the servers selected in Step 803 in the storage 150 (Step 818).

In Step 819, the manager server device 200 determines whether the performance values, which are work load performance information received in Step 818, are below the necessary performance sought by the user in the necessary performance information 2005. In Step 819, in the case where it is determined that the performance values of the work loads are not below the necessary performance, which is thresholds, sought by the user in the necessary performance information 2005, the manager server device 200 determines a dummy load amount to be subsequently measured (Step 820), and the process goes to Step 813. When the process proceeds, the dummy load amount is increased every time when the process in Step 820 is performed. In the case where it is determined that the performance values of the work loads are below the thresholds in Step 819, the process goes to Step 821.

In Step 821, the manager server device 200 determines whether processing is completed on all the work loads in the work load ID number 2001. In Step 821, in the case where the manager server device 200 determines that processing is not completed on all the work loads in the work load ID number 2001, the process goes to Step 802. In Step 821, in the case where the manager server device 200 determines that processing is completed on all the work loads in the work load ID number 2001, the process is ended.

As described above, the information processing system 100 repeats the processes from Step 813 to Step 818. Namely, in the case where there are the selected work load and the work load used in combination with the selected work load, the information processing system 100 applies an additional load to a resource, and monitors the performances of the selected work load and the work load used in combination with the selected work load as necessary while operating the selected work load and the work load used in combination with the selected work load on the server device, which is the information processing apparatus.

The performance table 152, which is the monitored result, shows the range where desired performances of the work loads can be obtained even though the resource is shared, so that it is possible to allocate the work loads to the server devices, which are the information processing apparatuses, so as to obtain desired performances.

### Second Embodiment

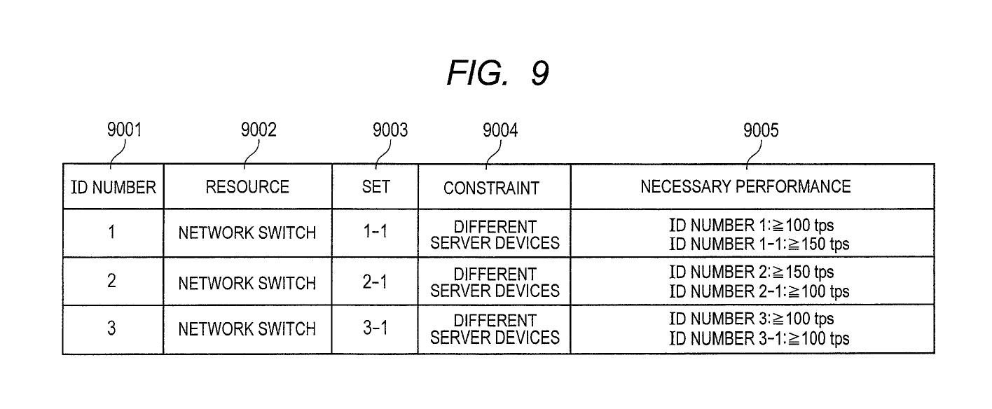

In a second embodiment, the allocation of work loads is exemplified in the case where work loads described in performance policy information 151 in FIG. 9 are inputted to the information processing system 100 according to the first embodiment.

For the initial state, suppose that the server devices 110, 120, 160, 170, and 250 are stopped for decreasing the power consumption of the information processing system 100. Moreover, according to the method described in the flowchart in FIG. 8 in the first embodiment, suppose that a performance table 152 is obtained for the work loads described in the performance policy information 151 in FIG. 9. Here, a work load “1” in an ID number 9001 in FIG. 9 is a work load A (WL_{A}), and a work load “1-1” in information 9003 about work loads to make a set is a work load B (WL_{B}). A work load corresponding to “2” in the ID number 9001 is a work load C (WL_{C}), and a work load “2-1” in the information 9003 about work loads to make a set is a work load D (WL_{D}). A work load corresponding to “3” in the ID number 9001 is a work load E (WL_{E}), and a work load “3-1” in the information 9003 about work loads to make a set is a work load F (WL_{F}). It is noted that in the case where a set of the work loads A and B, a set of the work loads C and D, and a set of the work load E and F are operated in the state in which there is no conflict, the sets of the work loads satisfy necessary performances in necessary performance information 9005 in FIG. 9 set by the user.

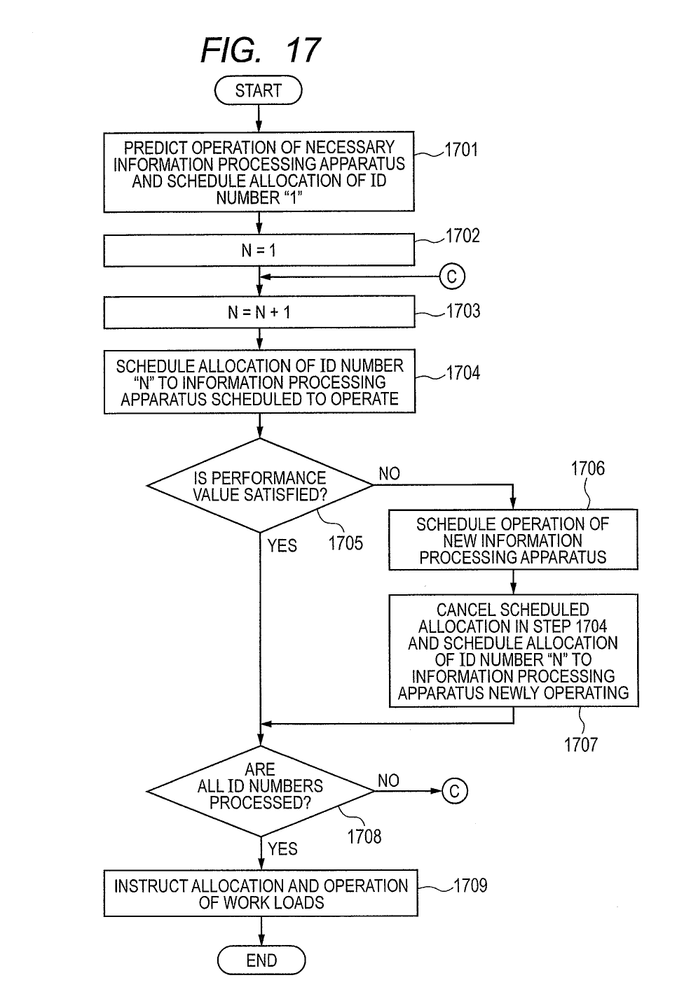

FIG. 17 is a flowchart of an example of the allocation and operation of the work loads according to the embodiment. In the embodiment, first, it is assumed that the work load of the ID number “1” is allocated as a necessary information processing apparatus is scheduled to operate (Step 1701), and then an integer N is set to one (Step 1702). One is added to the integer N (N=N+1) (Step 1703), and it is assumed that the work load of the ID number “N” is allocated to the information processing apparatus scheduled to operate (Step 1704). It is checked whether the work loads satisfy performance values set by the user in the necessary performance information 9005 (Step 1705). In the case where the work loads do not satisfy the performance values, a new information processing apparatus is scheduled to operate (Step 1706), and the work load “N” is scheduled to be allocated to the information processing apparatus newly scheduled to operate (Step 1707). In the case where the performance values are satisfied in Step 1705 or in the case where Step 1707 is finished, it is determined whether all the ID numbers are processed (Step 1708). In the case where all the ID numbers are not processed, the process returns to Step 1703. In the case where all the ID numbers are processed, the work load allocation and resource control unit 208 instructs the information processing apparatuses scheduled to operate to acquire the work loads according to the result of scheduled allocation, and instructs the information processing apparatuses scheduled to operate the acquired work loads (Step 1709).

In the following, the content of specific allocation according to the embodiment will be described.

In the embodiment, the manager server device 200 extracts work loads in ascending order of numbers in the work load ID number 9001. Therefore, first, the work load A of the work load ID number “1” and the work load B are extracted.

The manager server device 200 selects server devices to operate the work load A and the work load B based on the system configuration information 153, and stores the server devices on the memory of the manager server device 200 as the server devices scheduled to operate. For the order of selecting the server devices, such a configuration may be possible in which the order determined by the user in advance is stored in the storage device 150 as information about selection order, and the information is used. Here, the manager server device 200 determines that the work load A is operated on the server device 110 and the work load B is operated on the server device 120, and stores the server devices 110 and 120 on the memory of the manager server device 200 as the server devices scheduled to operate.

Subsequently, the manager server device 200 extracts the work load C and the work load D according to the ID number 9001. In order to reduce the number of server devices to operate for power savings, the manager server device 200 assumes to operate the work load C on the server device 110 and the work load D on the server device 120, and causes the work load performance predicting unit 207 to calculate, based on the performance table 152, the predicted performances of the work loads A to D that are assumed to apply, to the network switch 130₁, loads caused by the work load A, the work load B, the work load C, and the work load D based on the resource information 9002.

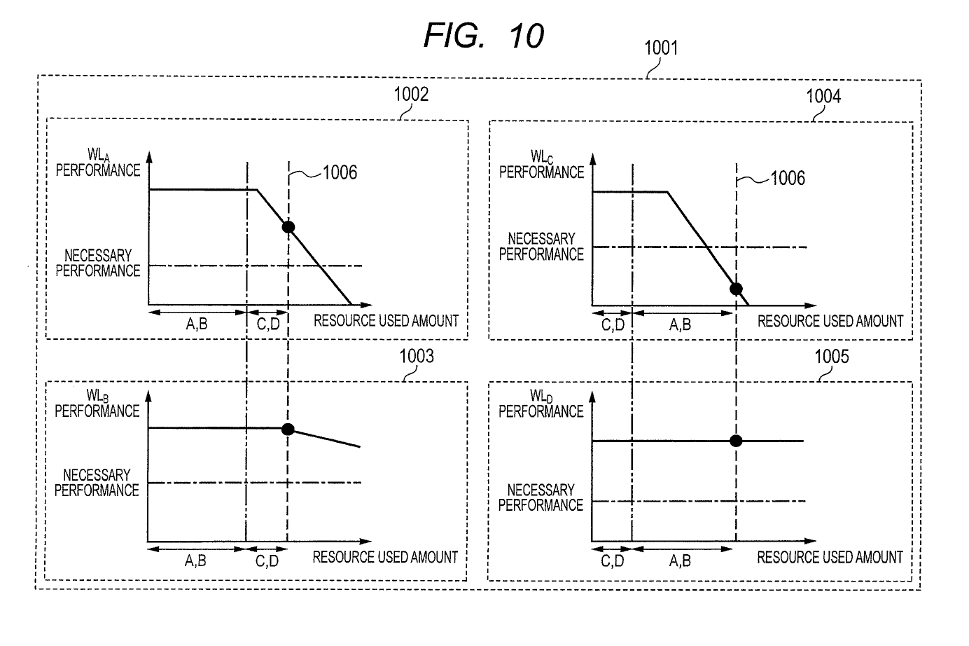

FIG. 10 is a graph 1001 schematically illustrating examples of the work loads A to D according to the embodiment. Graphs 1002 to 1005 illustrate the predicted performances of the work loads A to D with respect to the resource used amount. Since the single loads of the set of the work loads A and B and the set of the work loads C and D are applied to the network switch 130₁, it can be predicted to apply a load indicated by a broken line 1006 in total. The performance of the work load C indicated by the graph 1004 on the broken line 1006 is below the necessary performance.

The work load performance predicting unit 207 calculates the prediction, and the manager server device 200 determines the allocation of the work loads based on the necessary performance 9005 set by the user and the result calculated by the work load performance predicting unit 207. In the case of the embodiment, since it is determined that the performance of the work load C does not satisfy 150 tps, which is the performance of the work load set by the user, the manager server device 200 makes reference to the system configuration information 153 and work load disposition constraint information about work loads to make a set in the information 9003, and extracts the server devices 160 and 170 that are not connected to the network switch 130₁ but connected to the network switch 130₂. The manager server device 200 determines that the work load C is operated on the server device 160 and the work load D on the server device 170, and stores the server devices 160 and 170 on the memory of the manager server device 200 as the server devices scheduled to operate.

Subsequently, the manager server device 200 extracts the work load E and the work load F according to the ID number 9001. In order to reduce the number of server devices to operate for power savings, the manager server device 200 assumes to operate the work load E on the server device 110 and the work load F on the server device 120, and causes the work load performance predicting unit 207 to calculate, based on the performance table 152, the predicted performances of the work loads A, B, E, and F that are assumed to apply, to the network switch 130₁, loads caused by the work load A, the work load B, the work load E, and the work load F to the network switch 130₁ based on the resource information 9002.

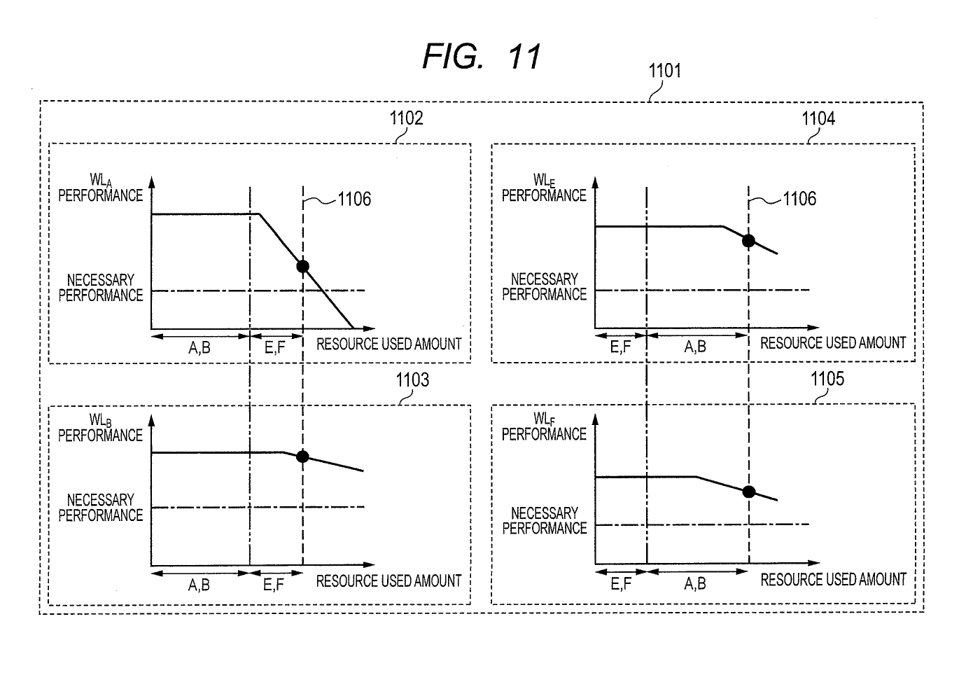

FIG. 11 is a graph 1101 schematically illustrating examples of the work loads A, B, E, and F according to the embodiment. Graphs 1102 to 1105 illustrate the predicted performances of the work loads A, B, E, and F with respect to the resource used amount. Since the single loads of the set of the work loads A and B and the set of the work load E and F are applied to the network switch 130₁, it can be predicted to apply a load indicated by a broken line 1106 in total. The performances of the work loads A, B, E, and F satisfy the necessary performances on the broken line 1106.

The work load performance predicting unit 207 calculates the prediction, and the manager server device 200 determines the allocation of the work loads based on the necessary performance 9005 set by the user and the result calculated by the work load performance predicting unit 207. In the case of the embodiment, since it is determined that the performances of the work loads A, B, E, and F satisfy all the necessary performances of the work loads set by the user, the manager server device 200 determines that the work load E is operated on the server device 110 together with the work load A and the work load F is operated on the server device 120 together with the work load B.

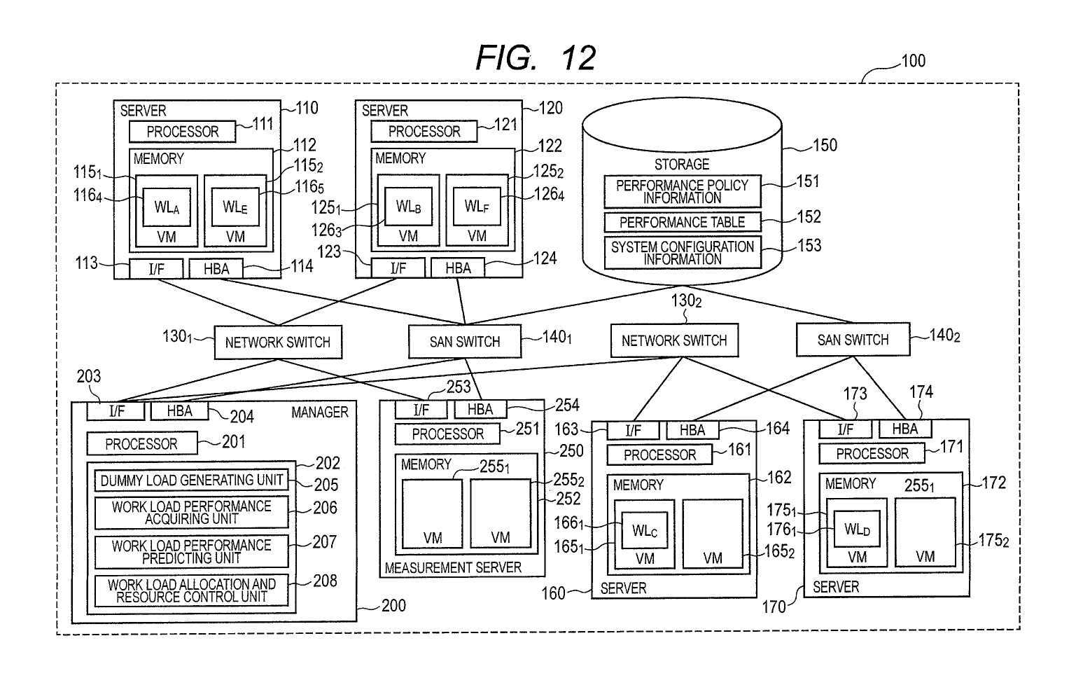

As described above, since the allocation of the work loads A to F is determined, the manager server device 200 causes the work load allocation and resource control unit 208 to cancel the halt of the server devices stored on the memory of the manager server device 200 as the server devices scheduled to operate, and operates the server devices. In the embodiment, the manager server device 200 operates the virtual machines 115₁ and 115₂ on the server device 110 and the server device 110, the virtual machines 125₁ and 125₂ on the server device 120 and the server device 120, the virtual machines 165₁ and 165₂ on the server device 160 and the server device 160, and the virtual machines 175₁ and 175₂ on the server device 170 and the server device 170. The manager server device 200 then disposes the work load A on the virtual machine 115₁, the work load B on the virtual machine 125₁, the work load C on the virtual machine 165₁, the work load D on the virtual machine 175₁, the work load E on the virtual machine 115₂, and the work load F on the virtual machine 125₂, and operates the work loads A to F. FIG. 12 shows the manner of allocating the work loads A to F according to the embodiment.

As described above, even in the state in which the network switch 130₁ is a shared resource, it is possible to implement allocation in which the work loads A to F can be operated in the state in which the necessary performances set by the user are satisfied. It is noted that in the embodiment, the ID number 9001 ranges from “1” to “3”. However, even in the case where there are an ID number “4” and more, allocation can be similarly made as for the ID numbers “1” to “3”.

When scheduled allocation for all the ID numbers in the ID number 9001 is finished, the work load allocation and resource control unit 208 instructs the server devices to acquire the work loads according to the result of allocation described above, and instructs the server devices to operate the acquired work loads.

In the embodiment, the embodiment is configured in which a single work load is disposed on a single virtual machine. However, a plurality of work loads may be disposed on a single virtual machine. Moreover, in the embodiment, the performances of the work loads A to F are predicted. For example, in the case where the performance of the work load A is more important than the performance of the work load B in the set of the work loads A and B, it is possible to perform the allocation of the work loads based on the performance of the important work load A when only the necessary performance of the work load A is inputted to the necessary performance information 9005.

### Third Embodiment

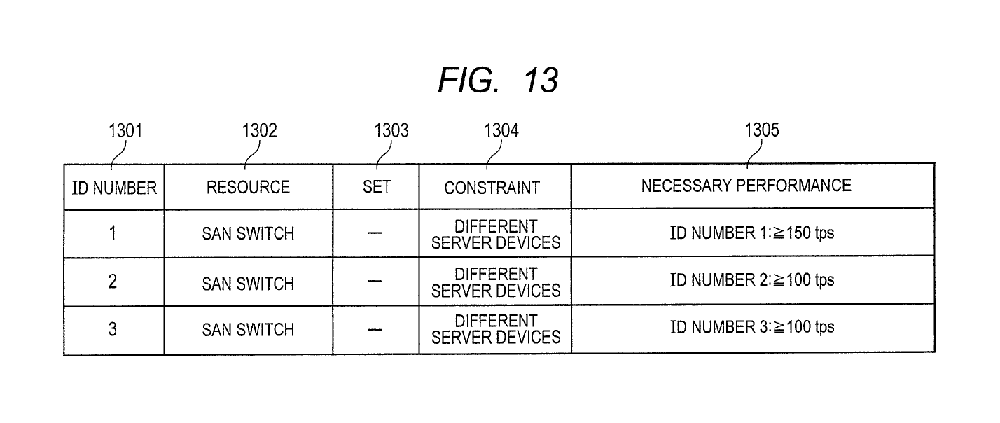

In a third embodiment, the allocation of work loads is exemplified in the case where work loads in performance policy information 151 in FIG. 13 are inputted to the information processing system 100 according to the first embodiment.

For the initial state, suppose that the server devices 110, 120, 160, 170, and 250 are stopped for decreasing the power consumption of the information processing system 100. Moreover, according to the method described in the flowchart in FIG. 8 in the first embodiment, suppose that a performance table 152 is obtained for the work loads described in the performance policy information 151 in FIG. 13. Here, suppose that a work load “1” in an ID number 1301 in FIG. 13 is a work load J (WL_{J}), a work load corresponding to “2” in the ID number 1301 is a work load K (WL_{K}), and a work load corresponding to “3” in the ID number 1301 is a work load L (WL_{L}). It is noted that in the case where the work loads J to L are operated in the state in which there is no conflict, the work loads J to L are supposed to satisfy necessary performances set by the user in necessary performance information 1305 in FIG. 13.

The allocation and operation of the work loads according to the embodiment can also be implemented according to the flowchart in FIG. 17 as similar to the second embodiment. The description of the flowchart in FIG. 17 is overlapped, and the description is omitted. In the following, the content of specific allocation according to the embodiment will be described.

In the embodiment, the manager server device 200 extracts work loads in ascending order of numbers in the work load ID number 1301. Therefore, first, the work load J of the work load ID number “1” is extracted.

The manager server device 200 selects a server device to operate the work load J based on the system configuration information 153, and stores the server device on the memory of the manager server device 200 as the server device scheduled to operate. For the order of selecting the server devices, such a configuration may be possible in which the order determined by the user in advance is stored in the storage device 150 as information about selection order, and the information is used. Here, the manager server device 200 determines that the work load J is operated on the server device 110, and stores the server device 110 on the memory of the manager server device 200 as the server device scheduled to operate.

Subsequently, the manager server device 200 extracts the work load K according to the ID number 1301. In order to reduce the number of server devices to operate for power savings, the manager server device 200 assumes to operate the work load K on the server device 110, and causes the work load performance predicting unit 207 to calculate, based on the performance table 152, the predicted performances of the work loads J and K that are assumed to apply loads caused by the work load J and the work load K to the SAN switch 140₁ based on the resource information 1302.

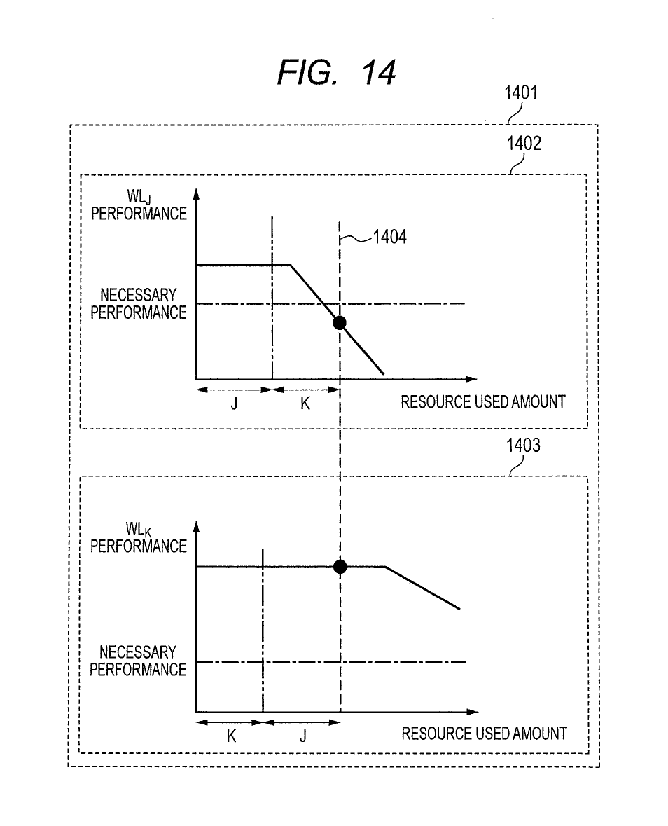

FIG. 14 is a graph 1401 schematically illustrating examples of the work loads J and K according to the embodiment. Graphs 1402 and 1403 illustrate the performances of the work loads J and K with respect to the resource used amount. Since the single loads of the work load J and the work load K are applied to the SAN switch 140₁, it can be predicted to apply a load indicated by a broken line 1404 in total. The performance of the work load J indicated by the graph 1402 on the broken line 1404 is below necessary performance.

The work load performance predicting unit 207 calculates the prediction, and the manager server device 200 determines the allocation of the work loads based on the necessary performance 1305 set by the user and the result calculated by the work load predicting unit 207. In the case of the embodiment, since it is determined that the performance of the work load J does not satisfy 150 tps, which is the performance of the work load set by the user, the manager server device 200 makes reference to the system configuration information 153, and extracts the server device 160 that is not connected to the SAN switch 140₁ but connected to the SAN switch 140₂. The manager server device 200 determines that the work load K is operated on the server device 160, and stores the server device 160 on the memory of the manager server device 200 as the server device scheduled to operate.

Subsequently, the manager server device 200 extracts the work load L according to the ID number 1301. In order to reduce the number of server devices to operate for power savings, the manager server device 200 assumes to operate the work load L on the server device 110, and causes the work load performance predicting unit 207 to calculate, based on the performance table 152, the predicted performances of the work loads J and L that are assumed to apply loads caused by the work load J and the work load L to the SAN switch 140₁ based on the resource information 1302.

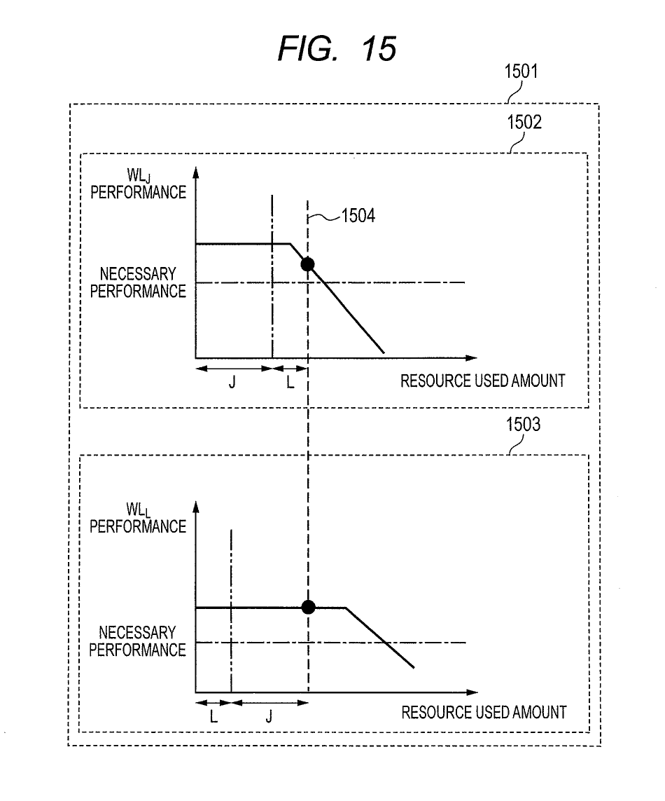

FIG. 15 is a graph 1501 schematically illustrating examples of the work loads J and L according to the embodiment. Graphs 1502 and 1503 illustrate the predicted performances of the work loads J and L with respect to the resource used amount. Since the single loads of the work load K and the work load L are applied to the SAN switch 140₁, it can be predicted to apply a load indicated by a broken line 1504 in total. The performances of the work loads J and L satisfy necessary performances on the broken line 1504.

The work load performance predicting unit 207 calculates the prediction, and the manager server device 200 determines the allocation of the work loads based on the necessary performance 1305 set by the user and the result calculated by the work load predicting unit 207. In the case of the embodiment, the manager server device 200 determines that the work load L is operated on the server device 110 together with the work load J and the work load K is operated on the server device 120.

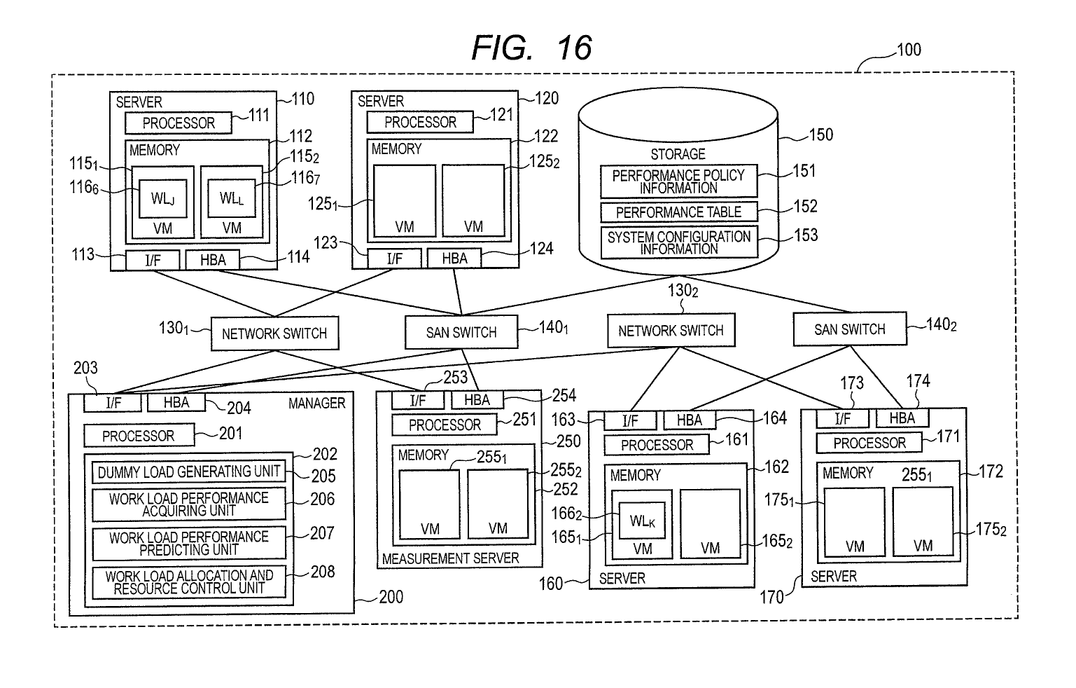

As described above, since the allocation of the work loads J to L is determined, the manager server device 200 causes the work load allocation and resource control unit 208 to cancel the halt of the server devices stored on the memory of the manager server device 200 as the server devices scheduled to operate. In the embodiment, the manager server device 200 operates the virtual machines 115₁ and 115₂ on the server device 110 and the server device 110, and the virtual machines 165₁ and 165₂ on the server device 160 and the server device 160. The manager server device 200 then disposes the work load J on the virtual machine 115₁, the work load K on the virtual machine 165₁, and the work load L on the virtual machine 115₂, and operates the work loads J to L. FIG. 16 shows the manner of allocating the work loads J to L according to the embodiment.

As described above, even in the state in which the SAN switch 140₁ is a shared resource, it is possible to implement allocation in which the work loads J to L can be operated in the state in which the necessary performances set by the user are satisfied. Moreover, in the embodiment, the server device 110 and the server device 160 are operated, and the other server devices are stopped. As in the embodiment, work loads are put together on a certain information processing apparatus in a range in which a shared resource is not overloaded, so that it is possible to stop or pause information processing apparatuses with no work loads allocated, and it is possible to aim the power savings of the information processing system.

It is noted that in the embodiment, the ID number 9001 ranges from “1” to “3”. However, even in the case where there are an ID number “4” and more, allocation can be similarly made as for the ID numbers “1” to “3”. In the embodiment, the embodiment is configured in which a single work load is disposed on a single virtual machine. However, a plurality of work loads may be disposed on a single virtual machine.

1. An operation management method for an information processing system including a first resource connected to a first information processing apparatus and to a second information processing apparatus, wherein:
an operation management computer of the information processing system applies an additional load to the first resource while operating a first combination of work loads including a first work load and a second work load in which the first work load is operated on the first information processing apparatus and the second work load is operated on the second information processing apparatus; and
the operation management computer performs first monitoring on performance of at least one of the first work load and the second work load.

2. The operation management method for an information processing system according to claim 1,
wherein the operation management computer determines allocation of the first combination to the first information processing apparatus and the second information processing apparatus based on a result of the first monitoring.

3. The operation management method for an information processing system according to claim 1, wherein:
the operation management computer further applies an additional load to the first resource while operating a second combination of work loads including a third work load and a fourth work load in which the third work load is operated on the first information processing apparatus and the fourth work load is operated on the second information processing apparatus, and performs second monitoring on performance of at least one of the third work load and the fourth work load; and
based on results of the first monitoring and the second monitoring, the operation management computer determines allocation of the first combination and the second combination to the first information processing apparatus and the second information processing apparatus.

4. The operation management method for an information processing system according to claim 1, wherein:
the information processing system further includes a second resource shared between a third information processing apparatus and a fourth information processing apparatus;
the operation management computer further applies an additional load to the first resource while operating a second combination of work loads including a third work load and a fourth work load in which the third work load is operated on the first information processing apparatus and the fourth work load is operated on the second information processing apparatus, and performs second monitoring on performance of at least one of the third work load and the fourth work load; and
based on results of the first monitoring and the second monitoring, the operation management computer determines allocation of the first combination and the second combination to the first information processing apparatus, the second information processing apparatus, the third information processing apparatus, and the fourth information processing apparatus.

5. The operation management method for an information processing system according to claim 1,
wherein the information processing apparatus is a server device, and the first resource is a network device.

6. The operation management method for an information processing system according to claim 5,
wherein the network device is a network switch.

7. The operation management method for an information processing system according to claim 5,
wherein the network device is a storage area network switch.

8. An operation management method for an information processing system including a resource possibly shared between work loads, wherein:
an operation management computer of the information processing system applies an additional load to the resource while operating a first work load in the information processing system; and
the operation management computer performs first monitoring on performance of the first work load.

9. The operation management method for an information processing system according to claim 8, wherein:
the operation management computer applies an additional load to the resource while operating a second work load in the information processing system, and performs second monitoring on performance of the second work load; and
based on results of the first monitoring and the second monitoring, the operation management computer determines allocation of the first work load and the second work load in the information processing system.

10. An information processing system including a first resource connected to a first information processing apparatus and to a second information processing apparatus, the system comprising:
an operation management computer configured to apply an additional load to the first resource while operating a first combination of work loads including a first work load and a second work load in which the first work load is operated on the first information processing apparatus and the second work load is operated on the second information processing apparatus, and perform first monitoring on performance of at least one of the first work load and the second work load.

11. The information processing system according to claim 10,
wherein the operation management computer determines allocation of the first combination to the first information processing apparatus and the second information processing apparatus based on a result of the first monitoring.

12. The information processing system according to claim 10, wherein:
the operation management computer further applies an additional load to the first resource while operating a second combination of work loads including a third work load and a fourth work load in which the third work load is operated on the first information processing apparatus and the fourth work load is operated on the second information processing apparatus, and performs second monitoring on performance of at least one of the third work load and the fourth work load; and
based on results of the first monitoring and the second monitoring, the operation management computer determines allocation of the first combination and the second combination to the first information processing apparatus and the second information processing apparatus.

13. The information processing system according to claim 10, wherein:
the information processing system further includes a second resource shared between a third information processing apparatus and a fourth information processing apparatus;
the operation management computer further applies an additional load to the first resource while operating a second combination of work loads including a third work load and a fourth work load in which the third work load is operated on the first information processing apparatus and the fourth work load is operated on the second information processing apparatus, and performs second monitoring on performance of at least one of the third work load and the fourth work load; and
based on results of the first monitoring and the second monitoring, the operation management computer determines allocation of the first combination and the second combination to the first information processing apparatus, the second information processing apparatus, the third information processing apparatus, and the fourth information processing apparatus.
